(19) United States
(12) Patent Application Publication
(10) Pub. No.: US 2026/0147877 A1
(43) Pub. Date: May 28, 2026

(54) CORRELATING STRUCTURED AND UNSTRUCTURED DOMAIN-SPECIFIC DATA

(71) Applicant: Microsoft Technology Licensing, LLC, Redmond, WA (US)

(72) Inventors: Aditi Kamlesh SHAH, Redmond, WA (US); Matthieu MAITRE, Seattle, WA (US); Sudipto RAKSHIT, Redmond, WA (US)

(21) Appl. No.: 18/963,450

(22) Filed: Nov. 27, 2024

(51) Int. Cl. G06F 21/55; G06F 16/36

(52) U.S. Cl. CPC G06F 21/552; G06F 16/367

(57) ABSTRACT

An improved knowledge graph for augmenting queries in a retrieval augmented generation system for generative artificial intelligence is constructed using entity data comprising information regarding a first entity of a first entity type and a second entity of a second entity type, the first and second entity types being defined by a domain-specific ontology for a knowledge domain. Relationship data for the knowledge graph comprises information regarding relationships between the first and second entities using relationship definitions from the domain-specific ontology. The knowledge graph is constructed by adding nodes corresponding to the entities and edges corresponding to the relationships. In some examples, the graph is used to identify cybersecurity threats applicable to a specific context.

### BACKGROUND

A typical threat intelligence (TI) report is a comprehensive document that provides detailed insights into cybersecurity threats, allowing organizations to understand and mitigate potential risks. Such reports are designed to inform security teams, executives, and decision-makers about emerging threats and vulnerabilities and contain information that helps in both proactive and reactive defenses, including entities, and relationships between entities. Entities include, but are not limited to, threat actors, tools, targets, vulnerabilities, attack patterns, campaigns, courses of action, as well as indicators of compromise. Specialized knowledge is sometimes required to appreciate the relationships between these (and other) entity types that may be referenced in a TI report.

### SUMMARY

Example solutions for constructing a knowledge graph are described herein. The disclosed examples are described in detail below with reference to the accompanying drawing figures listed below. The following summary is provided to illustrate some examples disclosed herein.

In some examples, a system constructs knowledge graph based on input data comprising unstructured data related to a specific knowledge domain. An entity extraction agent receives input data is and generates entity data comprising information regarding entities extracted from the unstructured data, wherein each of the entities correspond to an entity type defined by a domain-specific ontology corresponding to the knowledge domain. A relationship extraction agent receives the entity data and the input data and generates relationship data comprising information regarding relationships between the entities. The system then constructs knowledge graph by adding nodes corresponding to the entities and edges corresponding to the relationships. In some examples, the knowledge graph is useful for augmenting a generative artificial intelligence (GAI) query as further described below.

Additional implementation examples are described herein below.

### BRIEF DESCRIPTION OF THE DRAWINGS

The disclosed examples are described in detail below with reference to the accompanying drawing figures listed below:

FIG. 1 shows a block diagram showing by way of example a set of systems useful for generating a knowledge graph according to the technology described herein.

FIG. 2 shows a block diagram illustrating by way of example implementation of entity extraction pipeline.

FIG. 3 shows a block diagram illustrating by way of example a configuration of an attack techniques discovery agent.

FIG. 4 shows a block diagram illustrating by way of example a configuration of a relationship extraction pipeline.

FIG. 5 is a block diagram illustrating by way of example, a generative artificial intelligence (GAI) application using a knowledge graph generated according to the methodologies described herein.

FIG. 6 shows a flowchart illustrating by way of example procedure for configuring systems of FIG. 1 for generating a knowledge graph using a domain-specific ontology.

FIG. 7 is a flowchart illustrating by way of example a procedure for extracting, from a threat intelligence report, a list of entities and relationships.

FIG. 8 shows a flowchart illustrating by way of example a procedure for adding entities and relationships into a knowledge graph.

FIG. 9 shows a flowchart illustrating by way of example a procedure for using the knowledge graph generated as described herein.

FIG. 10 is a block diagram of an example computing device for implementing aspects disclosed herein.

Corresponding reference characters indicate corresponding parts throughout the drawings. Any of the figures may be combined into a single example or embodiment.

### DETAILED DESCRIPTION

Retrieval augmented generation (RAG) for models is a useful tool to overcome knowledge gaps in generative artificial intelligence (GAI) models and to improve the reliability of answers generated by the GAI models. RAG works by combining reliably accurate and relevant reference material into a query. A typical example is a query seeking information about a recent event. Because the model was trained using historical information prior to the recent event, the model lacks knowledge about the recent event. To fill in that knowledge gap, a RAG system appends relevant material to the query with an instruction such as, “answer the above questions based on the following information.”

Reference material used by a RAG system can be sourced from publicly accessible data sources such as the public internet, or it can be a private dataset, which is data that the GAI model was not trained on. How reference material is preprocessed (e.g., divided into segments, indexed, and retrieved) impacts the information presented to the GAI model and therefore has a significant impact on the quality of the answer provided by the GAI model.

An existing approach splits large unstructured documents into smaller segments, referred to herein as “snippets.” At query time, the GAI application retrieves embedding vectors corresponding to the snippets that are most similar to the embedded query are identified and selects the corresponding snippets for augmenting the query for the GAI model. This approach is followed by various large language model (LLM) frameworks, also referred to as LLM-based orchestration frameworks, an example of which is the LangChain framework available from LangChain, Inc. However, this approach struggles to form associations needed to answer queries that require traversing disparate pieces of information through their shared attributes and is unable to holistically understand summarized semantic concepts over large data collections or large individual documents.

Microsoft, Inc.'s GraphRAG uses GAI models to create a knowledge graph based on a body of reference material. A knowledge graph is a structured representation of information that identifies relationships between entities (such as people, places, or concepts). Each node in the knowledge graph represents an entity or a concept, while edges represent the relationships between them. Knowledge graphs in RAG systems act as an enhanced, semantically rich, retrieval mechanism and allow the GAI model to better understand and leverage relationships between concepts, leading to more accurate and relevant information being provided in the augmented query in a RAG system.

GraphRAG divides input reference materials into snippets and extracts entities, relationships, and key claims from the snippets using a GAI model. Next, a hierarchical clustering of the graph is performed based on the Leiden technique for detecting communities or clusters of related entities within networks. Finally, summaries are generated of each community and its constituents, which aids in a holistic understanding of the dataset. The resulting knowledge graph, along with community summaries and graph machine learning outputs, are used to identify snippets for augmenting prompts at query time.

GraphRAG is able to extract entities and relationships present in the input reference material, but it has certain limitations. For instance, the relationship extraction is limited by what information is present in the input reference material as well as a limit on the output length that the GAI model can output, which for current models is about 4,000 tokens.

Certain knowledge domains, which rely on specialized knowledge and have a specialized vocabulary, exacerbate challenges in detecting relationships between entities. For example, threat intelligence (TI) refers to any information about new and emerging cybersecurity threats, and comprises both structured and unstructured data. TI reports include structured and unstructured data that include security articles, blog posts, technical reports, whitepapers, etc. that are generated and published by different security organizations and other entities.

Aspects of the disclosure increase the number of valid relationships among the entities to improve the overall quality of the information provided to the GAI model which generates an improved answer, which is overall more reliable than using prior approaches. The technology described herein improves the quality of answers generated by GAI models, which include LLMs, small language models, multi-model models, etc. GAI models drive sophisticated chatbots that enable human researchers in various fields to access a tremendous amount of information via a simple to use natural language chatbot user interface. Using RAG, GAI models can answer queries directed to a body of reference material, which includes structured and/or unstructured data, upon which it has never been trained. In an implementation of RAG, snippets of the reference material that relate to the query are selected for inclusion with the query, and the GAI model is instructed to answer the query using the selected segments of information. The technology described herein improves the selection of the segments in at least two different ways.

In one example way, technology described herein applies a domain specific ontology to the reference material in generating a knowledge graph. For instance, in the knowledge domain of TI, a system maps source material to the TI ontology to more accurately and completely identify relationships between entities that are either explicitly referenced by the source material or can be reasonably deduced by the ontology. This results in a more complete list of entities and more accurate characterization of the relationships between the entities, as the ontology provides an authoritative semantic framework for understanding the entity types in the TI reports.

In another example way, the technology described herein inverts the traditional approach for extracting relationship information. Whereas traditionally, a system identifies semantically processes the source material to identify relationships which are then added as edges to the knowledge graph, in the presently described technology, a system imposes possible relationships defined by a domain-specific ontology upon all the entities extracted (or deduced) from the source material, and then a filtering step removes relationships that are inconsistent with what the source material describes. As a result, a more robust set of relationships is identified which results in more complete web of connections between entities which translates to better correlative power of the GAI in generating an answer from the user query. The end result is an answer from the GAI model that is significantly improved in quality over prior approaches.

FIG. 1 shows a block diagram showing by way of example a set of systems 100 useful for generating a knowledge graph according to the technology described herein. The systems include domain-specific database 10, entity extraction pipeline 20, relationship extraction pipeline 30, and knowledge graph builder 40. An example implements each of these systems as a multitenant service, which comprises a scalable cluster of virtual machines or containerized application instances, across which the compute load is distributed using one or more load balancers. Alternative examples provide system as a unitary application or a scalable microservices application deployed on one or more physical servers. Additional features included based on implementation but not shown or described herein include management interfaces, firewall and/or other security mechanisms, etc. Alternatively embodiments combine systems 100 into fewer systems than shown, or are further subdivided into additional distinct systems with functionality of the shown systems 100 distributed accordingly. Accordingly, the representations of systems 100 are presented only as a possible implementation, or as one possible conceptual division of functionality, and should therefore not be considered restrictive.

Domain-specific database 10 is a database containing unstructured and structured data relating to a particular knowledge domain. For the purpose of illustration and without limitation, domain specific data for threat intelligence (TI) includes TI reports that are structured, e.g., Open Source Intelligence (OSINT) articles and/or Structured Threat Information Expression (STIX), or are unstructured TI reports, such as blogs, research articles, social media posts, incidence response reports, press releases, security conferences, and government advisories. For the purpose of this disclosure, the term, “TI report” refers to a particular article or component thereof that relates to a particular threat. In alternative embodiments, domain-specific data relates to other knowledge domains, such as medicine, politics, national security, astronomy, celebrity gossip, or any other domain in which there is a need to gather into a coherent knowledge base information from separate disparate structured and/or unstructured data sets which can then be used to augment queries related to the particular knowledge domain to a GAI model.

Entity extraction pipeline 20 employs generative GAI or natural language processing (NLP) agents to extract entities from domain-specific data, as further described below with reference to FIG. 3. Entities are terms that reference a physical thing or idea and are defined in an ontology. In the field of threat intelligence, STIX is a language for describing threat intelligence in a structured manner, and accordingly defines a set of domain objects relevant to threat intelligence. These domain objects can correspond to various entity types including indicators, attack patterns, threat actors, campaigns, intrusion sets, malware and tools, observed data, courses of action (CoA), and tactics, techniques, and procedures (TTPs). Each domain object is interpreted as an entity suitable for extraction. Additional data objects that correspond to additional entity types that are not specific to a domain-specific ontology, such as places, times and dates, people, and characteristics, are also extracted. Accordingly, entity extraction pipeline generates a list of entities discovered in domain-specific data from domain-specific database 10.

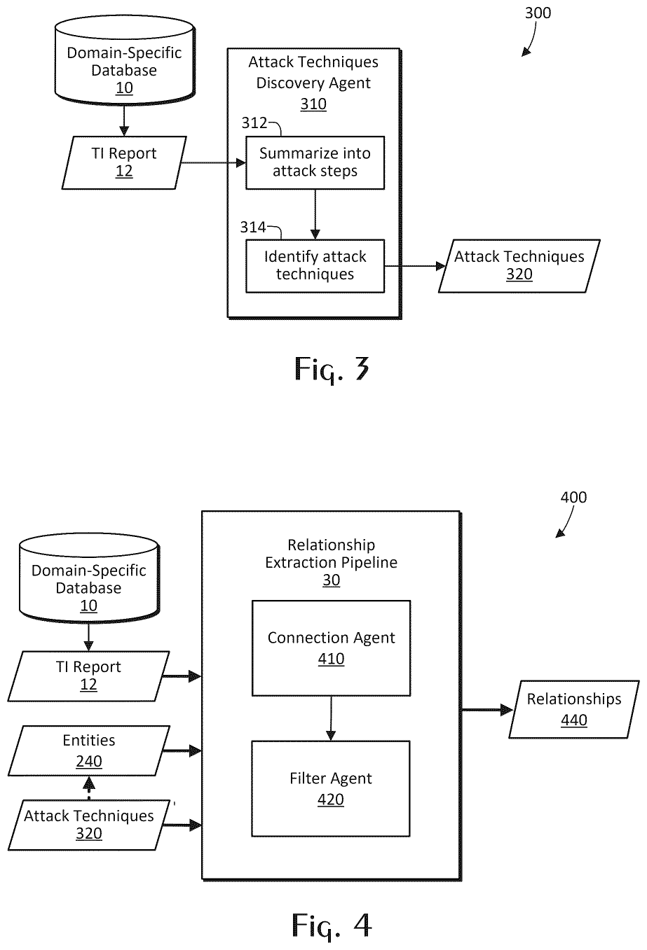

Relationship extraction pipeline 30 discovers relationships between entities discovered by entity extraction pipeline 20. Relationship extraction pipeline 30 uses GAI agents and/or non-GAI NLP agents as further described below with reference to FIGS. 3 and 4 to generate a list of relationships from domain-specific data and entities discovered by entity extraction pipeline 20. A relationship is commonly expressed as a verb in the domain-specific data. For example, suppose an unstructured TI report mentioned, “the Raven Network used phishing emails targeting senior executives at Global Trust Bank.” In this case, the verb “used” would identify the tactic (“phishing emails”) as related to Raven Network by the relationship, “used by.” From this sentence, it can be established that a first entity “Raven Network” of entity type “threat actor” is related to a second entity “phishing emails” of entity type “tactic,” and that they are connected by a relationship, “used by.” Additional relationships can be discovered as well. For example, Global Trust Bank “includes” senior executives, and that Raven Network as well as the phishing emails “target” the senior executives at Global Trust Bank.

Knowledge graph builder 40 receives entities and relationships from entity extraction pipeline 20 and relationship extraction pipeline 30, respectively, to generate knowledge graph 50. Knowledge graph 50 comprises nodes that represent entities and edges that represent relationships. While knowledge graphs may be represented graphically, knowledge graph builder will encode the graph in some serialized form, such as a JavaScript Object Notation (JSON) (or other data-interchange format) file. Each entity and each relationship have zero or more attributes, which are discovered by entity extraction pipeline 20 and passed to knowledge graph builder 40 with the list of discovered entities. An attribute is a characteristic of an entity, such as the birthdate of a person. While a birthdate can be represented as a separate entity, it is usually simpler to include it as an attribute since it is not usually helpful to associate multiple people with the same birthdate simply because they happen to share a birthdate.

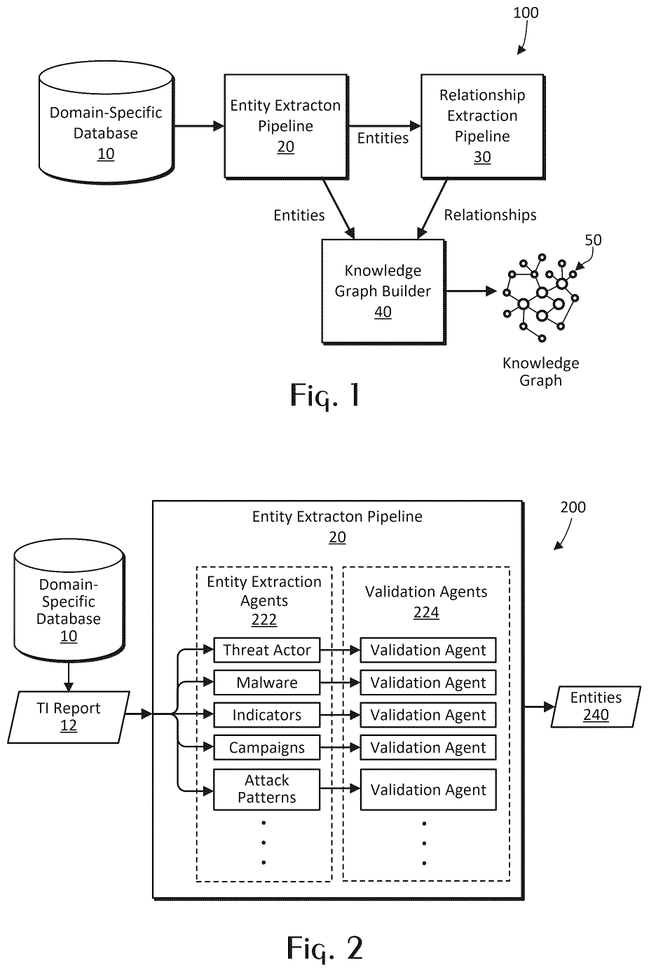

FIG. 2 shows a block diagram illustrating by way of example implementation 200 of entity extraction pipeline 20. Entity extraction pipeline 20 includes entity extraction agents 222 and validation agents 224. In an embodiment, each entity extraction agent 222 corresponds to an entity type defined by a domain-specific ontology and is implemented as a GAI model-based agent. In an embodiment, a first entity extraction agent generates first entity data identifying one or more first entities of a first entity type (such as a list of entities of the first type), and a second extraction agent generates second entity data identifying one or more second entities of a second entity type (such as a list of entities of the second type). As the term is used herein, “agent” refers to a GAI model configured to operate autonomously or semi-autonomously, and programmable to carry out multi-step tasks independently, such as retrieving information, summarizing it, and generating reports. Agents are capable of accessing specific databases or application programming interfaces (APIs), and are thus capable of automating complex workflows, interpreting real-time data, or acting as virtual assistants with specialized knowledge. In the present case, agents 222 are each specialized (e.g., trained on a specific set of data relevant to their task or otherwise instructed in a specific way) to identify, within the input TI report 12, entity candidates, and to deduce or infer information regarding that entity based on the context and other information provided in the report. For example, the “threat actor” agent is capable of identifying a threat actor that is mentioned in the TI report 12 and deducing from context and/or ontological information, if it is a nation state actor or a private organization.

For each entity extraction agent, a validation agent validates the output from the entity extraction agent. This provides a sanity check to ensure that the results from the entity extraction agent are grounded. In one embodiment including an NLP process, embedding vectors are generated for TI report (or other domain-specific input data) and for the list of entities output of each entity extraction agent. The embedding vectors of the input and output are then compared to determine a relevance score (e.g., confidence score) indicating a degree of relevance between the extracted entities output from the entity extraction agents and the input to the entity extraction agent. In another embodiment, a natural language inference (NLI) analyzer (not shown) is used to confirm that the output of the entity extraction agent is entailed by the input. In either case, a score is generated and compared to a threshold that indicates the output generated by the entity extraction agent is consistent with the unstructured data.

If the validation agent determines that the entity extraction agent generated non-sane output, then remedial actions may be taken. In an illustrative implementation, the entity extraction agent found to generate an invalid output is required with an addendum identifying the prior query that the prior result and stating it is invalid, e.g. is not entailed or is not relevant to the input. If repeated attempts fail, an alert or error is raised or logged, and the invalid result of the extraction agent is disregarded.

For each input TI report 12 (or other domain-specific article from domain-specific database 10) a set of entities 240 corresponding thereto is generated. The list of entities 240 may be formatted as a JSON or other data-interchange format file and is used as further described below to extract relationships from domain specific database 10 and knowledge graph 50, mentioned above with reference to FIG. 1 and as further explained below.

In an exemplary implementation, a sampling of entity types and properties discovered by entity extraction agent 20 are as listed in Table 1.

TABLE 1

| Entity Type | Properties |
|---|---|
| Artifact (array of bytes, as base64-encoded | mime_type, payload_bin, url, hashes, |
| string, or linking to file-like payload) | encryption_algorithm, decryption_key |
| Campaign (a grouping of adversarial | name, description, aliases, first_seen, |
| behaviors that describes a set of malicious | last_seen, objective |
| activities or attacks that occur over a period | |
| of time against a specific set of targets) | |
| Domain Name (represents the properties of | value |
| a network domain name) | |
| Identity (can represent actual individuals, | name, description, roles, identity_class (e.g., |
| organizations, or groups, as well as classes | an individual or organization), sectors, |
| of individuals, organizations, systems, or | contact_information |
| groups) | |
| Intrusion set (a grouped set of adversarial | name, description, aliases, first_seen, |
| behaviors and resources with common | last_seen, goals, resource_level, |
| properties believed to be orchestrated by a | primary_motivation, secondary_motivations |
| single organization - can capture multiple | |
| Campaigns or other activities tied by a | |
| shared attributes or indicating a common | |
| known or unknown Threat Actor) | |
| Location (represents a geographic location) | name, description, region, country, |
| | administrative_area, city |
| Process (represents common properties of | is_hidden, pid, created_time, cwd, |
| an instance of a computer program) | command_line, environment_variables |
| Tool (legitimate software that can be used | name, description, tool_types, aliases, |
| by thrat actors to perform attacks) | killchainphases, tool_version |
| Vulnerability (a flaw in software that can be | Name, description, external_references |
| used by a hacker to gain access to a system | |
| or network) | |

FIG. 3 shows a block diagram illustrating by way of example a configuration 300 of an attack techniques discovery agent 310. Attack techniques discovery agent 310 is a special-purpose summarization agent presented as an example mechanism of preprocessing information from domain-specific database 10 to deriving or inferring information therefrom that can enhance the overall discovery of relationships. Attack techniques discovery agent 310 includes a first summarization stage and a second characterization stage. In alternative embodiments, each stage is performed by a separate agent connected in a pipeline arrangement. As described herein a single agent performs the first stage of operation 312 in which the input TI report 12 is received, and a set of attack steps is detected and summarized. In the second stage of operation 314, the attack steps are characterized as a named attack technique. The second stage of operation is performed based on a predefined list of attack techniques and corresponding definitions, in which attack techniques discovery agent 310 compares the summarized attack steps generated in first stage of operation 312 with the definitions to identify the closest related attack technique in the predefined list. Attack techniques discovery agent 310 outputs one or more identified attack techniques 320 for each input TI report 12.

FIG. 4 shows a block diagram illustrating by way of example a configuration 400 of a relationship extraction pipeline 30. Relationship extraction pipeline 30 comprises a connection agent 410 and a filter agent 420. Connection agent 410, in one embodiment, is an NLP-based agent configured for identifying relationships between entities discovered by entity extraction pipeline 20 discussed above with reference to FIG. 2. Connection agent 410, based on a pre-defined domain-specific ontology (not shown) identifies possible relationships between entities based on their respective entity types, e.g., without considering relationships mentioned in the input data (e.g., the TI report). In an embodiment, connection agent 410 identifies every possible relationship between every entity in the list of entities 240 and attack techniques 320. As referenced herein, “entities 240” should be understood to include attack techniques 320. By way of example, Table 2 lists all possible relationships between entity types. In each row of Table 2, a source entity type is identified, a relationship type is identified, and a target entity type is identified. A sampling of source entity type and target entity type are listed in Table 1.

TABLE 2

| Source | Relationship | |
|---|---|---|
| Entity Type | Type | Target Entity Types |
| campaign | attributed-to | intrusion-set, threat-actor |
| campaign | targets | identity, location, vulnerability |
| indicator | indicates | attack-pattern, campaign, |
| | | infrastructure, intrusion-set, malware, |
| | | threat-actor, tool |
| infrastructure | consists-of | artifact, autonomous-system, |
| | | directory, domain-name, email-addr, file, |
| | | url, ipv4-addr, ipv6-addr, mac-addr, |
| | | process, software, user-account, windows- |
| | | registry-key, x509-certificate |
| infrastructure | has | vulnerability |
| infrastructure | uses | infrastructure |
| intrusion-set | hosts | infrastructure |
| intrusion-set | targets | identity, location, vulnerability |
| malware | beacons-to | infrastructure |
| malware | controls | malware |
| malware | exploits | vulnerability |
| malware | uses | attack-pattern, infrastructure, |
| | | malware, tool |
| threat-actor | hosts | infrastructure |
| threat-actor | located-at | location |
| threat-actor | targets | identity, location, vulnerability |
| tool | targets | identity, infrastructure, location, |
| | | vulnerability |
| ipv4-addr | resolves-to | mac-addr |
| ipv6-addr | belongs-to | autonomous-system |
| attack- | uses | malware, tool |
| pattern | | |
| course-of- | remediates | malware, vulnerability |
| action | | |

Referring to Table 2, as an example, if a first entity is identified that is of type “threat-actor,” connection agent 410 will initially identify a “targets” type relationship with every entity of type “identity,” “location,” and “vulnerability” since these are possible target entity types of source entity type “threat-actor,” according to Table 2.

Having identified one or more possible relationships between entities based on their respective entity types, filter agent 420 verifies each possible relationship for consistency with TI report 12. In an embodiment, when a possible relationship has been identified between a first entity type and a second entity type, filter agent 420 generates a verified instance of that relationship between a first entity of the first entity type and a second entity of the second entity type when it determined the existence of that relationship is consistent with TI report 12. In one implementation, filter agent 420 is powered by a GAI model, and is instructed to look at each relationship initially identified by connection agent 410 and, referring to TI report 12, remove from the initial list ones of the entities that are unsupported by TI report 12. Hence, instead of generating a list by directly discovering relationships in TI report 12, relationship extraction pipeline 30 operates in the inverse way—the GAI agent is used to remove relationships from an initial list of all possible relationships as defined by an ontology. In this example, verified instances of possible relationships are those remaining after unsupported relationships have been removed.

Relationships 440 include information regarding all the relationships described or deduced from TI report 12 that are both identified by connection agent 410 and determined be consistent with TI report 12 by filter agent 420.

FIG. 5 is a block diagram 500 illustrating, by way of example, an illustrative implementation of GAI application 506 using knowledge graph 50 generated according to the foregoing methodologies. In an embodiment, knowledge graph 50 is used to identify a potential cyberthreat, such as a potential current or historical attack on a target entity. A user 502 inputs query 504 into GAI application 506. GAI application 506 generates a query graph and/or embedding vectors to identify portions of knowledge graph 50 and embedding vectors 510, which are stored in database 508 that are most relevant to query 504. The relevant information is then obtained from database 508 and combined with query 504 to form an augmented query 512 which is submitted to GAI model 514. GAI model 514 responds with Answer 516 which is forwarded back to user 502 (e.g., as Answer 518). Because knowledge graph 50 is generated with a more complete and accurate set of relationships between entities, more complete and accurate information is combined with query 504 when generating augmented query 512, which results in a higher quality answer 518. In an embodiment, answer 518 identifies a potential cyberthreat, such as a potential attack and target(s) of the attack. In one implementation, knowledge graph 50 is communicated to (e.g., transmitted to or stored in a location accessible to) a security system that uses knowledge graph 50 to identify and, in some cases mitigate against, potential cyberthreats. Examples of threat mitigation actions that might be triggered in response to a potential cybersecurity attack include generating an alert (e.g., a real-time alert at a user interface controlled by the security system); or isolating, quarantining, modifying or deactivating an entity (e.g. target entity that might have been compromised, such as a user account, device, system, process, application, service etc.), or modifying or removing an access privilege associated with such an entity.

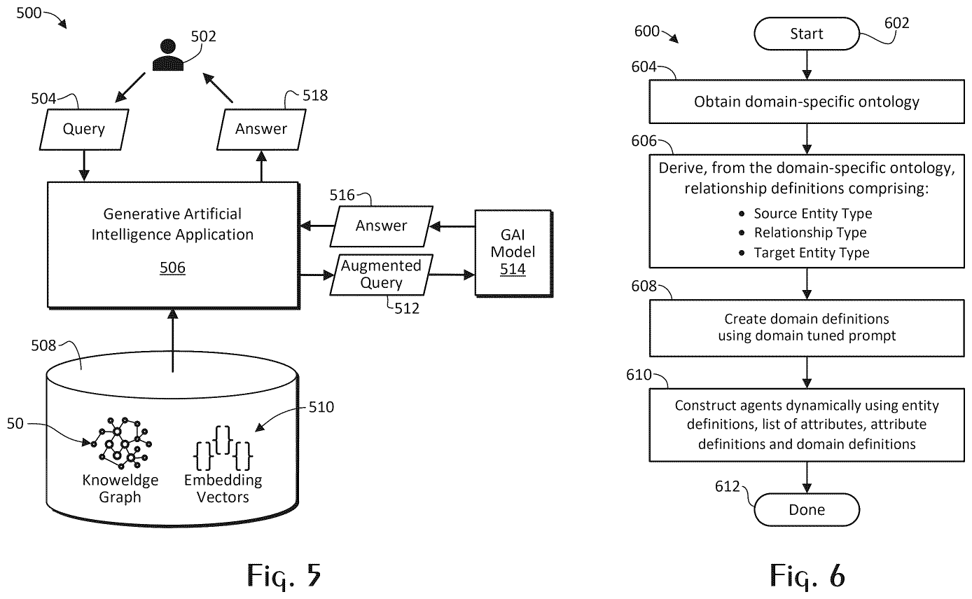

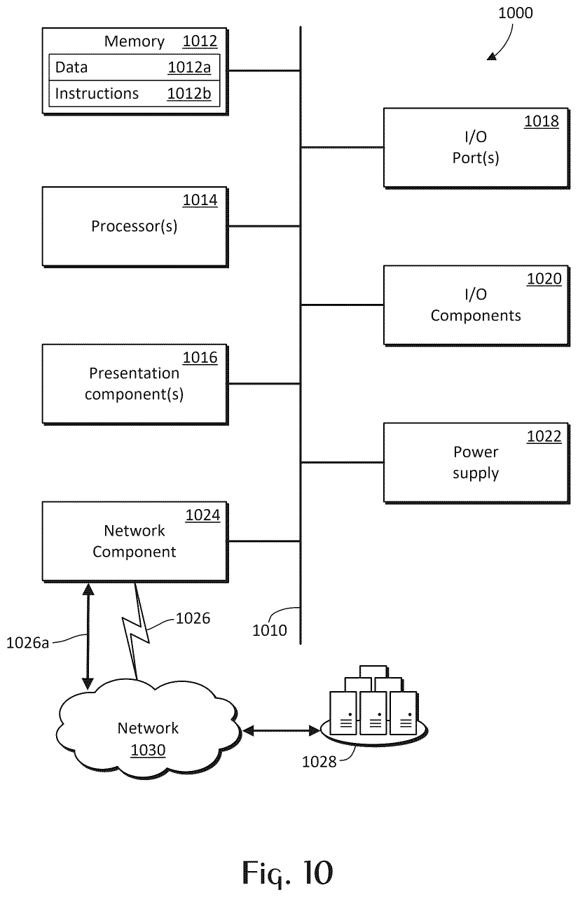

FIG. 6 shows a flowchart illustrating by way of example procedure 600 for configuring systems 100 of FIG. 1 for generating a knowledge graph using a domain-specific ontology. This procedure can be implemented using a general-purpose computer system such as the one shown in FIG. 10. The procedure begins as indicated by start block 602 and proceeds to operation 604 wherein a domain-specific ontology is received. For example, an ontology that is received can be the Structured Threat Information Exchange (STIX), however, other standard, or specially-constructed ontologies can be used for the cyber security knowledge domain or other knowledge domains.

In operation 606, a list of relationship definitions is derived from the domain-specific ontology. Table 2 is an example of such a list, including for each entry, a source entity type, a relationship type, and a target entity type.

In operation 608, domain definitions are created using a domain tuned prompt. By way of example, the domain specific ontology comprises information included in Table 1 and Table 2, plus additional information not shown, including definitions of each entity, entity property, relationship, and relationship property. In an example, the MITRE Adversarial Tactics, Techniques and Common Knowledge (ATT&CK) Matrix, created by the Mitre Corporation, is a comprehensive framework defining 625 categories of techniques used by cybercriminals. In an illustrative implementation in the field of cyber threat intelligence, a GAI agent may be instructed to define each technique described in the MITRE ATT&CK Matrix as a short sentence.

In operation 610, entity extraction agents 222 are constructed dynamically using entity definitions, list of attributes, attribute definitions, and domain definitions. In an example implementation, entity extraction agents 222 are automatically derived from the domain definition by way of scraping and/or using public APIs. The instructions are a template where the scraped or pulled information is injected into appropriate placeholders. For example, for the entity extraction agents, the template includes the entity definition, list of attributes, their data types and definitions, and the JSON format which the agent must output. The procedure then ends as indicated by block 612.

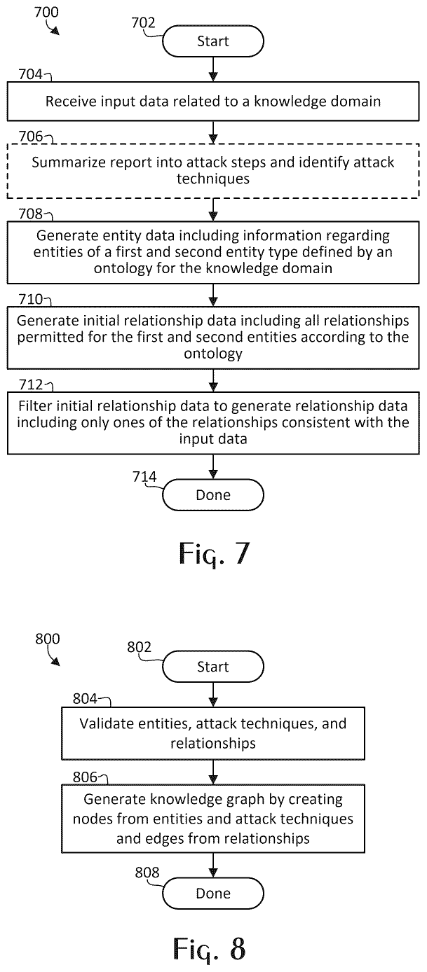

FIG. 7 is a flowchart illustrating by way of example a procedure 700 for extracting, from input data such as a threat intelligence report, a list of entities and relationships and using the list of entities and relationships to generate a knowledge graph. While the specific example being described relates to cyber threat intelligence in particular, the approach is valid for other knowledge domains as previously explained. Operations of procedure 700 are, in an illustrative implementation, performed by entity extraction pipeline 20 and relationship extraction pipeline 30, described above with reference to FIGS. 1-4.

The procedure begins as indicated by start block 702 and proceeds to operation 704 wherein input data related to a knowledge domain is received. For example, referring to FIGS. 2-4, input data comprising a threat intelligence report 12 may be pulled from domain-specific database 10. Alternatively, an existing list of entities and relationships may be augmented by identifying a new threat intelligence report, or set of reports, recently issued from an authority, such as an individual or a private or public organization dedicated to cyber security.

In operation 706, in an example wherein the input data is a TI report, the report is summarized into attack steps and then zero or more attack techniques are identified as previously described above with reference to FIG. 3.

In operation 708, entity data including information regarding entities of a first and second entity type is generated. The first and second entity types are defined by an ontology for the knowledge domain. In an example embodiment, first and second GAI agents corresponding to the first and second entity types are responsible for extracting entities and attributes from the input data as previously described above with reference to FIG. 2.

In operation 710, initial relationship data is generated. The initial relationship data includes all relationships permitted for the first and second entities according to the ontology. In an example embodiment, a connection agent generates the initial relationship data comprising a list of relationships from entities using relationship definitions as previously described above with reference to FIG. 4. In an example wherein the input data comprises a TI report, the initial relationship data also includes relationships between the first and second entities and the attack techniques discovered in operation 706.

In operation 712, the initial relationship data is filtered to generate relationship data including only those of the relationships in the initial relationship data that are consistent with the input data. In an example embodiment, a filter agent generates a filtered list of relationships by removing relationships that are not relevant to the report, as previously described above with reference to FIG. 4. The procedure then ends as indicated by done block 714.

FIG. 8 shows a flowchart 800 illustrating by way of example a procedure for converting the list of entities and relationships resulting from the procedure discussed above with reference to FIG. 7 into a knowledge graph. This procedure is, in an illustrative implementation, performed by knowledge graph builder 40, discussed above with reference to FIG. 1.

The procedure begins at start block 802 and flows to operation 804 wherein entities, attack techniques, and relationships are validated. In an exemplary embodiment, the entities, attack techniques and relationships are compared to a domain-specific ontology to ensure that each corresponds to an entity type, attack technique, and relationship type associated with the domain-specific ontology. In a first example approach, a GAI agent is asked to role play as a senior cyber security expert performing the task of judging the work of a junior colleague. The “work” refers to the output from the previous agent. This approach is useful for entities that are deduced and are not explicitly present in the text. In another example approach, regular expressions are used to ensure that the extracted entities are indeed present in the text. This approach is useful for entities that are known to be present in the text and helps exclude hallucinated or fabricated entities.

In operation 806, the knowledge graph is constructed by adding nodes from the entities and attack techniques, and edges connecting nodes from the relationships. The procedure then completes as indicated by done block 808.

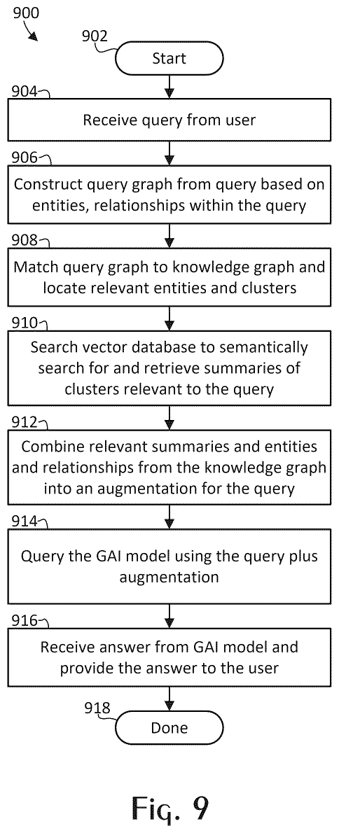

FIG. 9 shows a flowchart illustrating by way of example a procedure 900 for using the knowledge graph generated by the method described above with reference to FIGS. 7 and 8. Procedure 900 is, in an illustrative implementation, performed by GAI application 506 described above with reference to FIG. 5, and will be described with reference to FIG. 5.

Procedure 900 begins at start block 902 and proceeds to operation 904 wherein a query 504 is received from a user 502. In operation 906, a query graph (not shown) is constructed from the query based on entities and relationships mentioned in the query. Then in operation 908, the query graph is matched to knowledge graph 50 retrieved from database 508. In operation 910, vectors 510 from database 508 is searched to identify summaries relevant to query 504. These summaries, in an illustrative implementation, are generated from clusters or communities of nodes and relationships in knowledge graph 50, as described above with reference to GraphRAG as an example RAG system. For example, the embedding vectors are generated from the query and compared with embedding vectors 510 of database 508 to identify the embedding vectors 510 that are closest in value to the ones generated from the query. The identified embedding vectors correspond to summaries that are determined to be the most semantically relevant to the query based on the comparison of the embedding vectors.

In operation 912, query 504 is augmented using the most relevant summaries and entities and relationships from database 508. In operation 914, GAI model 514 is queried using the augmented query 512, which generates an answer 516. In operation 916, the answer is received from GAI model 514 and provided (as shown at answer 518) to user 502. Procedure 900 then ends as indicated by block 918.

### Experimental Results

In an example study, over six thousand questions related to the knowledge domain of threat intelligence were submitted to two different GAI applications. The baseline application used GraphRAG, and the novel approach used the approaches described herein. A separate GAI model was used to grade the answers from one to five, with one corresponding to a completely incorrect answer, grade three corresponding to an answer that is mostly correct, and grade five indicating an answer that is completely correct. These results are summarized in Table 3. An example question read, “Which countries are primarily targeted by Star Blizzard in their phishing campaign?” with the expected answer being “United States, United Kingdom, Ukraine.” The study showed a significant improvement using the above-described approaches with the mean baseline grade at 2.92 while novel approach having a mean score of 4.13, with 69% more completely correct answers as compared to the baseline.

TABLE 3

| | | Novel Approach |
|---|---|---|
| Grade | Baseline Count | Count |
| 1 | 2972 | 1053 |
| 2 | 501 | 348 |
| 3 | 27 | 31 |
| 4 | 298 | 427 |
| 5 | 2815 | 4745 |

### Additional Examples

A system includes a processor and a memory storing instructions, the memory and the instructions configured to cause the processor to: receive input data related to a knowledge domain, the input data comprising unstructured data; generate entity data comprising first entity data and second entity data, wherein the first entity data is generated using a first entity extraction agent, the first entity data comprising information from the input data regarding entities of a first entity type and the second entity data is generated using a second entity extraction agent, the second entity data comprising information from the input data regarding entities of a second entity type, wherein the first and second entity types are defined in a domain-specific ontology for the knowledge domain; generate relationship data comprising information regarding relationships between the entities in the entity data; and construct a knowledge graph by adding nodes corresponding to the entities in the entity data and edges corresponding to the relationships in the relationship data.

Alternatively, or in addition to the other examples described herein, examples include any combination of the following:
Wherein the generation of the relationship data comprises generating initial relationship data by including, in the initial relationship data, information regarding every possible relationship permitted by the domain-specific ontology for the entities in the entity data, the instructions further causing the processor to: evaluate, using a GAI filter agent, a level of consistency between each of the relationships in the initial relationship data and the input data; and include in the relationship data only information regarding ones of the relationships in the initial relationship data that are consistent with the input data as determined by the filter agent.
Wherein a relationship definition for a relationship type is derived from the domain-specific ontology and includes a source entity type, the relationship type, and a target entity type, the relationship definition being used (i) in the generating of the relationship data and (ii) by the filter agent.
Wherein the first and second entity extraction agents generate initial entity data comprising entities of a corresponding entity type and the instructions further cause the processor to provide the initial entity data from the first and second entity extraction agents to corresponding first and second validation agents, wherein the first and second validation agents perform natural language processing operations to validate that the entities of the initial entity data are consistent with the input data, the validation agents removing, from the initial entity data, ones of the entities of the initial entity data that are inconsistent with the input data, the entity data being an aggregation of initial entity data that was validated and not removed by the first and second validation agents.
Wherein: the knowledge domain is cyber threat intelligence; the input data is a threat intelligence report; and the instructions further cause the processor to summarize, using an attack techniques discovery agent, the threat intelligence report into a plurality of attack steps and to identify, from the plurality of attack steps, an attack technique, wherein the relationship data further includes information regarding relationships between entities and the attack technique.
Wherein the instructions further cause the processor to store the knowledge graph in a database accessible by a GAI application, the GAI application being operable to augment user-submitted queries to a GAI model using the knowledge graph.

A method comprising: receiving input data related to a knowledge domain, the input data comprising unstructured data; generating entity data comprising information regarding a first entity of a first entity type and a second entity of a second entity type, the first and second entity types being defined by a domain-specific ontology for the knowledge domain; generating initial relationship data comprising information regarding relationships between the first and second entities by including in the initial relationship data every relationship permitted for the first and second entities by the domain-specific ontology; generating, by a filter agent, relationship data by evaluating a level of consistency between the relationships in the initial relationship data and the input data, the relationship data including only those relationships in the initial relationship data that are consistent with the input data; and constructing a knowledge graph by adding nodes corresponding to the entities in the entity data and edges corresponding to the relationships in the relationship data.

Alternatively, or in addition to the other examples described herein, examples include any combination of the following:
Wherein a first entity extraction agent is instructed to identify, from the input data, entities of the first entity type and a second entity extraction agent is instructed to identify, from the input data, entities of a second entity type that is different from the first entity type, wherein the entity data comprises the entities of the first type identified by the first entity extraction agent and the entities of the second type identified by the second entity extraction agent.
Wherein the first and second entity extraction agents generate initial entity data, the method further comprising: validating, using first and second validation agents corresponding to the first and second entity extraction agents, that entities of the initial entity data are consistent with the input data, the validating comprising dropping ones of the entities of the initial entity data that are determined to be not supported by or relevant to the input data, wherein the entity data comprises only the entities that are not dropped.
wherein: relationship definitions for the first and second relationship types are derived from the domain-specific ontology, the relationship definitions including a source entity type, a relationship type, and a target entity type; and the relationship definitions are used to generate the relationship data and by the filter agent.
Wherein the knowledge domain is cyber threat intelligence and the input data is a threat intelligence report.
Wherein the method further comprises summarizing, by an attack technique discovery agent, the threat intelligence report into a plurality of attack steps and identifying, from the plurality of attack steps, an attack technique, wherein the relationship data further includes information regarding a relationship between the first entity and the attack technique.
Wherein the method further comprises storing the knowledge graph in a database accessible by a GAI application, the GAI application being operable to augment user-submitted queries to a GAI model using the knowledge graph.

A computer storage medium embodies instructions that, upon execution by a processor, cause a processor to: receive input data comprising unstructured data related to a knowledge domain; generate entity data comprising information regarding a first entity of a first entity type and a second entity of a second entity type, the first and second entity types being defined by a domain-specific ontology for the knowledge domain; generate relationship data comprising information regarding relationships between the first entity and the second entity using relationship definitions from the domain-specific ontology; and construct a knowledge graph by adding nodes corresponding to the entities and edges corresponding to the relationships.

Alternatively, or in addition to the other examples described herein, examples include any combination of the following:
Wherein the entity data is generated by first and second entity extraction agents, wherein the first entity extraction agent instructed to identify, from the input data, entities of the first entity type and the second entity extraction agent is instructed to identify, from the input data, entities of the second entity type that is different from the first entity type.
Wherein the first and second entity extraction agents generate initial entity data comprising information regarding entities of the first and second entity types and the instructions are further configured to validate, using first and second validation agents that correspond to the first and second entity extraction agents, that entities of the initial entity data of the corresponding entity type are supported by or relevant to the input data, the validation comprising dropping ones of the entities that are determined to be not supported by or relevant to the input data, wherein the entity data comprises only the validated entities that are not dropped.
Wherein the generation of relationship data comprises: generating initial relationship data from the entity data by including, in the initial relationship data, information regarding relationships permitted by the domain-specific ontology for the entities; and evaluating, using a filter agent and for the relationships in the initial relationship data, a level of consistency to the input data, and to include in the relationship data only ones of the relationships in the initial relationship data that are consistent with the input data.
Wherein: the instructions are further configured to derive, from the domain-specific ontology, a relationship definition for a relationship type, the relationship definition including a source entity type, the relationship type, and a target entity type; and the relationship definition is used in the generating of the initial relationship data and by the filter agent.
Wherein: the knowledge domain is cyber threat intelligence; the input data is a threat intelligence report; and the instructions are further configured to: summarize the threat intelligence report into a plurality of attack steps; and identify, from the plurality of attack steps, an attack technique, wherein the relationship data further includes information regarding a relationship between the first entity and the attack technique.
Wherein the instructions are further configured to store the knowledge graph in a database accessible by a ARI application, the GAI application being operable to augment user-submitted queries to a GAI model using the knowledge graph.

### Example Operating Environment

FIG. 10 is a block diagram of an example computing device 1000 (e.g., a computer storage device) for implementing aspects disclosed herein, and is designated generally as computing device 1000. In some examples, one or more computing devices 1000 are provided for an on-premises computing solution. In some examples, one or more computing devices 1000 are provided as a cloud computing solution. In some examples, a combination of on-premises and cloud computing solutions are used. Computing device 1000 is but one example of a suitable computing environment and is not intended to suggest any limitation as to the scope of use or functionality of the examples disclosed herein, whether used singly or as part of a larger set.

Computing device 1000 should not be interpreted as having any dependency or requirement relating to any one or combination of components/modules illustrated. The examples disclosed herein can be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples can be practiced in a variety of system configurations, including personal computers, laptops, smart phones, mobile tablets, hand-held devices, consumer electronics, specialty computing devices, etc. The disclosed examples can also be practiced in distributed computing environments when tasks are performed by remote-processing devices that are linked through a communications network.

Computing device 1000 includes a bus 1010 that directly or indirectly couples the following devices: computer storage memory 1012, one or more processors 1014, one or more presentation components 1016, input/output (I/O) ports 1018, I/O components 1020, a power supply 1022, and a network component 1024. While computing device 1000 is depicted as a seemingly single device, multiple computing devices 1000 can work together and share the depicted device resources. For example, memory 1012 is distributed across multiple devices, and processor(s) 1014 is housed with different devices.

Bus 1010 represents one or more busses (such as an address bus, data bus, or a combination thereof). Although the various blocks of FIG. 10 are shown with lines for the sake of clarity, delineating various components can be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 10 and the references herein to a “computing device.” Memory 1012 can take the form of the computer storage media referenced below and operatively provide storage of computer-readable instructions, data structures, program modules and other data for the computing device 1000. In some examples, memory 1012 stores one or more of an operating system, a universal application platform, or other program modules and program data. Memory 1012 is thus able to store and access data 1012a and instructions 1012b that are executable by processor 1014 and configured to carry out the various operations disclosed herein.

In some examples, memory 1012 includes computer storage media. Memory 1012 can include any quantity of memory associated with or accessible by the computing device 1000. Memory 1012 can be internal to the computing device 1000 (as shown in FIG. 10), external to the computing device 1000 (not shown), or both (not shown). Additionally, or alternatively, the memory 1012 can be distributed across multiple computing devices 1000, for example, in a virtualized environment in which instruction processing is carried out on multiple computing devices 1000. For the purposes of this disclosure, “computer storage media,” “computer storage medium”, “computer-storage memory,” “memory,” and “memory devices” are synonymous terms for the computer-storage memory 1012, and none of these terms include carrier waves or propagating signaling.

Processor(s) 1014 includes any quantity of processing units that read data from various entities, such as memory 1012 or I/O components 1020. Specifically, processor(s) 1014 are programmed to execute computer-executable instructions for implementing aspects of the disclosure. The instructions can be performed by the processor, by multiple processors within the computing device 1000, or by a processor external to the client computing device 1000. In some examples, the processor(s) 1014 are programmed to execute instructions such as those illustrated in the flow charts discussed below and depicted in the accompanying drawings. Moreover, in some examples, the processor(s) 1014 represent an implementation of analog techniques to perform the operations described herein. For example, the operations are performed by an analog client computing device 1000 and/or a digital client computing device 1000. Presentation component(s) 1016 present data indications to a user or other device. Exemplary presentation components include a display device, speaker, printing component, vibrating component, etc. It should be understood that computer data can be presented in a number of ways, such as visually in a graphical user interface (GUI), audibly through speakers, wirelessly between computing devices 1000, across a wired connection, or in other ways. I/O ports 1018 allow computing device 1000 to be logically coupled to other devices including I/O components 1020, some of which can be built in. Example I/O components 1020 include, for example but without limitation, a microphone, joystick, game pad, satellite dish, scanner, printer, wireless device, etc.

Computing device 1000 can operate in a networked environment via network component 1024 using logical connections to one or more remote computers. In some examples, the network component 1024 includes a network interface card and/or computer-executable instructions (e.g., a driver) for operating the network interface card. Communication between the computing device 1000 and other devices can use any protocol or mechanism over any wired or wireless connection. In some examples, network component 1024 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1024 communicates over wireless communication link 1026 and/or a wired communication link 1026a to a remote resource 1028 (e.g., a cloud resource) across network 1030. Various different examples of communication links 1026 and 1026a include a wireless connection, a wired connection, and/or a dedicated link, and in some examples, at least a portion is routed through the internet.

Although described in connection with an example computing device 1000, examples of the disclosure are capable of implementation with numerous other general-purpose or special-purpose computing system environments, configurations, or devices. Examples of well-known computing systems, environments, and/or configurations that suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices might accept input from the user in any way, including from input devices such as a keyboard or pointing device, via gesture input, proximity input (such as by hovering), and/or via voice input.

Examples are described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium for storing information for access by a computing device. In contrast, communication media typically embody computer readable instructions, data structures, program modules, or the like in a modulated data signal such as a carrier wave or other transport mechanism and include any information delivery media.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In examples involving a general-purpose computer, aspects of the disclosure transform the general-purpose computer into a special-purpose computing device when configured to execute the instructions described herein.

It will be understood that the benefits and advantages described above can relate to one embodiment or to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer storage medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

As used herein, the term “set” is non-empty, and can also be referred to as a “group.” The term, “list” refers to a set of related logical objects and not necessarily to a physical listing of the logical objects.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there might be additional elements other than the listed elements. The term “exemplary” is intended to mean “an example of.” The phrase “one or more of the following: A, B, and C” means “at least one of A and/or at least one of B and/or at least one of C.”

While the aspects of the disclosure have been described in terms of various examples with their associated operations, a person skilled in the art would appreciate that a combination of operations from any number of different examples is also within scope of the aspects of the disclosure.

What is claimed is:

1. A system comprising:
a processor; and
a memory storing instructions, the memory and the instructions configured to cause the processor to:
receive input data related to a knowledge domain, the input data comprising unstructured data;
generate entity data comprising first entity data and second entity data, wherein the first entity data is generated using a first entity extraction agent, the first entity data regarding entities of a first entity type, the second entity data is generated using a second entity extraction agent, the second entity data regarding entities of a second entity type, wherein the first and second entity types are defined in a domain-specific ontology for the knowledge domain;
generate relationship data regarding relationships between the entities in the entity data; and
construct a knowledge graph by adding nodes corresponding to the entities in the entity data and edges corresponding to the relationships in the relationship data,
wherein the knowledge graph is used for augmenting a generative artificial intelligence (GAI) query.

2. The system of claim 1, wherein the generation of the relationship data comprises generating initial relationship data by including, in the initial relationship data, information regarding every possible relationship permitted by the domain-specific ontology for the entities in the entity data, the instructions further causing the processor to:
evaluate, using a GAI filter agent, a level of consistency between each of the relationships in the initial relationship data and the input data; and
include in the relationship data only information regarding ones of the relationships in the initial relationship data that are consistent with the input data as determined by the filter agent.

3. The system of claim 2, wherein a relationship definition for a relationship type is derived from the domain-specific ontology and includes a source entity type, the relationship type, and a target entity type, the relationship definition being used (i) in the generating of the relationship data and (ii) by the filter agent.

4. The system of claim 1, wherein the first and second entity extraction agents generate initial entity data comprising entities of a corresponding entity type and the instructions further cause the processor to provide the initial entity data from the first and second entity extraction agents to corresponding first and second validation agents, wherein the first and second validation agents perform natural language processing operations to validate that the entities of the initial entity data are consistent with the input data, the validation agents removing, from the initial entity data, ones of the entities of the initial entity data that are inconsistent with the input data, the entity data being an aggregation of initial entity data that was validated and not removed by the first and second validation agents.

5. The system of claim 1, wherein:
the knowledge domain is cyber threat intelligence;
the input data is a threat intelligence report; and
the instructions further cause the processor to summarize, using an attack techniques discovery agent, the threat intelligence report into a plurality of attack steps and to identify, from the plurality of attack steps, an attack technique, wherein the relationship data further includes information regarding relationships between entities and the attack technique.

6. The system of claim 1, wherein the instructions further cause the processor to store the knowledge graph in a database accessible by a GAI application, the GAI application being operable to augment user-submitted queries to a GAI model using the knowledge graph.

7. A computerized method comprising:
receiving input data related to a knowledge domain, the input data comprising unstructured data;
generating entity data regarding a first entity of a first entity type and a second entity of a second entity type, the first and second entity types being defined by a domain-specific ontology for the knowledge domain;
generating initial relationship data regarding relationships between the first and second entities by including in the initial relationship data every relationship permitted for the first and second entities by the domain-specific ontology;
generating, by a filter agent, relationship data including evaluating a level of consistency between the relationships in the initial relationship data and the input data, the relationship data including only those relationships in the initial relationship data that are consistent with the input data; and
constructing a knowledge graph including adding nodes corresponding to the entities in the entity data and edges corresponding to the relationships in the relationship data,
wherein the knowledge graph is used for augmenting a generative artificial intelligence (GAI) query.

8. The method of claim 7, wherein a first entity extraction agent is instructed to identify, from the input data, entities of the first entity type and a second entity extraction agent is instructed to identify, from the input data, entities of a second entity type that is different from the first entity type, wherein the entity data comprises the entities of the first type identified by the first entity extraction agent and the entities of the second type identified by the second entity extraction agent.

9. The method of claim 8, wherein the first and second entity extraction agents generate initial entity data, the method further comprising:
validating, using first and second validation agents corresponding to the first and second entity extraction agents, that entities of the initial entity data are consistent with the input data, the validating comprising dropping ones of the entities of the initial entity data that are determined to be not supported by or relevant to the input data, wherein the entity data comprises only the entities that are not dropped.

10. The method of claim 7, wherein:
relationship definitions for the first and second relationship types are derived from the domain-specific ontology, the relationship definitions including a source entity type, a relationship type, and a target entity type; and
the relationship definitions are used to generate the relationship data and by the filter agent.

11. The method of claim 7, wherein:
the knowledge domain is cyber threat intelligence; and
the input data is a threat intelligence report.

12. The method of claim 11, further comprising:
summarizing, by an attack technique discovery agent, the threat intelligence report into a plurality of attack steps; and
identifying, from the plurality of attack steps, an attack technique, wherein the relationship data further includes information regarding a relationship between the first entity and the attack technique.

13. The method of claim 7, further comprising storing the knowledge graph in a database accessible by a GAI application, the GAI application being operable to augment user-submitted queries to a GAI model using the knowledge graph.

14. A computer storage medium embodying instructions that, upon execution by a processor, cause the processor to:
receive input data comprising unstructured data related to a knowledge domain;
generate entity data regarding a first entity of a first entity type and a second entity of a second entity type, the first and second entity types being defined by a domain-specific ontology for the knowledge domain;
generate relationship data regarding relationships between the first entity and the second entity using relationship definitions from the domain-specific ontology; and
construct a knowledge graph including adding nodes corresponding to the entities and edges corresponding to the relationships,
wherein the knowledge graph is used for augmenting a generative artificial intelligence (GAI) query.

15. The computer storage medium of claim 14, wherein:
the entity data is generated by first and second entity extraction agents, wherein the first entity extraction agent instructed to identify, from the input data, entities of the first entity type and the second entity extraction agent is instructed to identify, from the input data, entities of the second entity type that is different from the first entity type.

16. The computer storage medium of claim 15, wherein the first and second entity extraction agents generate initial entity data comprising information regarding entities of the first and second entity types and the instructions are further configured to:
validate, using first and second validation agents that correspond to the first and second entity extraction agents, that entities of the initial entity data of the corresponding entity type are supported by or relevant to the input data, the validation comprising dropping ones of the entities that are determined to be not supported by or relevant to the input data, wherein the entity data comprises only the validated entities that are not dropped.

17. The computer storage medium of claim 14, wherein the generation of relationship data comprises:
generating initial relationship data from the entity data by including, in the initial relationship data, information regarding relationships permitted by the domain-specific ontology for the entities; and
evaluating, using a filter agent and for the relationships in the initial relationship data, a level of consistency to the input data, and to include in the relationship data only ones of the relationships in the initial relationship data that are consistent with the input data.

18. The computer storage medium of claim 17, wherein:
the instructions are further configured to derive, from the domain-specific ontology, a relationship definition for a relationship type, the relationship definition including a source entity type, the relationship type, and a target entity type; and
the relationship definition is used in the generating of the initial relationship data and by the filter agent.

19. The computer storage medium of claim 14, wherein:
the knowledge domain is cyber threat intelligence;
the input data is a threat intelligence report; and
the instructions are further configured to:
summarize the threat intelligence report into a plurality of attack steps; and
identify, from the plurality of attack steps, an attack technique, wherein the relationship data further includes information regarding a relationship between the first entity and the attack technique.

20. The computer storage medium of claim 14, the instructions being further configured to store the knowledge graph in a database accessible by a GAI application, the GAI application being operable to augment user-submitted queries to a GAI model using the knowledge graph.
